(19) United States
(12) Patent Application Publication
(10) Pub. No.: US 2022/0269102 A1
(43) Pub. Date: Aug. 25, 2022

(54) OPTICAL UNIT

(71) Applicant: NIDEC CORPORATION, Kyoto (JP)

(72) Inventors: Kazuhiro SAZAI, Kyoto (JP); Keishi OTSUBO, Kyoto (JP)

(21) Appl. No.: 17/679,093

(22) Filed: Feb. 24, 2022

(30) Foreign Application Priority Data
Feb. 25, 2021 (JP) 2021-029218

(51) Int. Cl. G02B 27/64; G03B 5/06

(52) U.S. Cl. CPC G02B 27/646; G03B 5/06; G03B 2205/0015; H01F 7/02

(57) ABSTRACT

An optical unit includes a fixed body, a movable body having an optical module having an optical axis, a support portion arranged on the fixed body and supporting the movable body, and a swing mechanism that swings the movable body with respect to the fixed body. The support portion is located radially inside about the optical axis with respect to the swing mechanism. The optical unit further includes a protruding portion that is arranged on a first one of the movable body and the fixed body, and protrudes from the first one of the movable body and the fixed body toward a second one to interpose a gap between the movable body and the fixed body. A shortest distance between the protruding portion and the second one of the movable body and the fixed body is shorter than a shortest distance between the movable body and the fixed body.

### CROSS-REFERENCE TO RELATED APPLICATIONS

The present invention claims priority under 35 U.S.C. § 119 to Japanese Patent Application No. 2021-029218 filed on Feb. 25, 2021, the entire content of which is incorporated herein by reference.

### FIELD OF THE INVENTION

The present invention relates to an optical unit.

### BACKGROUND

An image blur sometimes occurs due to camera shake during capturing a still image or moving image with a camera. For this reason, an image stabilization device has been put into practical use to enable clear imaging with image blur prevention. When the camera shakes, the image stabilization device can remove image blur by correcting the position and orientation of a camera module according to the shake.

As an anti-vibration mechanism, an imaging device in which a moving end of a movable member is defined is being studied. In a conventional imaging device, a movable side rotation limiting means limits the rotation of the movable member.

In the conventional imaging device, when an impact is applied to a camera or the like and an excessive force is applied, the movable body may move excessively with respect to a fixed body, and the movable body may be out of a control range. Once the movable body is out of the control range, the movable body cannot be properly controlled.

### SUMMARY

An optical unit according to a certain aspect of the present invention includes a fixed body, a movable body having an optical module having an optical axis, a support portion arranged on the fixed body and supporting the movable body, and a swing mechanism that swings the movable body with respect to the fixed body. The support portion is located radially inside about the optical axis with respect to the swing mechanism. The optical unit further includes a protruding portion that is arranged on a first one of the movable body and the fixed body, and protrudes from the first one of the movable body and the fixed body toward a second one to interpose a gap between the movable body and the fixed body. A shortest distance between the protruding portion and the second one of the movable body and the fixed body is shorter than a shortest distance between the movable body and the fixed body.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic perspective view of a smartphone including an optical unit of the present embodiment;

FIG. 2 is a schematic perspective view of the optical unit of the present embodiment;

FIG. 3 is a schematic exploded view of the optical unit of the present embodiment;

FIG. 4 is a schematic top view of the optical unit of the present embodiment;

FIG. 5 is an enlarged view of a part of FIG. 4;

FIG. 6 is a schematic cross-sectional view taken along line VI-VI of FIG. 4;

FIG. 7 is a schematic cross-sectional view taken along line VII-VII of FIG. 4;

FIG. 8 is a schematic cross-sectional view taken along line VIII-VIII of FIG. 4;

FIG. 9 is a schematic cross-sectional view of the optical unit of the present embodiment;

FIG. 10 is a schematic exploded view of a fixed body in the optical unit of the present embodiment;

FIG. 11 is a schematic exploded view of the optical unit of the present embodiment;

FIG. 12 is a schematic top view of the optical unit of the present embodiment;

FIG. 13 is a schematic cross-sectional view taken along line XIII-XIII of FIG. 12;

FIG. 14 is a schematic cross-sectional view of the optical unit of the present embodiment;

FIG. 15 is a schematic exploded view of the optical unit of the present embodiment;

FIG. 16 is a schematic cross-sectional view of the optical unit of the present embodiment;

FIG. 17 is a schematic perspective view of a movable body in the optical unit of the present embodiment;

FIG. 18 is a schematic exploded view of the optical unit of the present embodiment;

FIG. 19 is a schematic cross-sectional view of the optical unit of the present embodiment;

FIG. 20 is a schematic exploded perspective view of the optical unit of the present embodiment;

FIG. 21 is a schematic perspective view of the optical unit of the present embodiment; and

FIG. 22 is a schematic exploded perspective view of the optical unit of the present embodiment.

### DETAILED DESCRIPTION

An exemplary embodiment of an optical unit according to the present invention will be described below with reference to the drawings. Note that in the drawings, the same or corresponding parts will be denoted by the same reference symbols and description of such parts will not be repeated. Note that in the description of the present application, an X-axis, a Y-axis, and a Z-axis that are orthogonal to one another may be used to facilitate understanding of the invention. Here, it should be noted that the X-axis, the Y-axis, and the Z-axis do not limit the orientation of the optical unit during use.

An optical unit of the present embodiment is suitably used as an optical component of a smartphone.

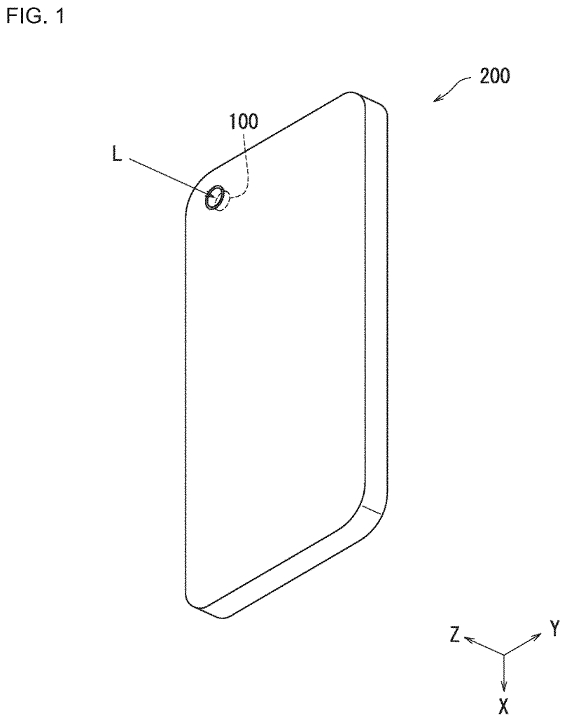

First, a smartphone 200 including an optical unit 100 of the present embodiment will be described with reference to FIG. 1. FIG. 1 is a schematic perspective view of the smartphone 200 including the optical unit 100 of the present embodiment.

As illustrated in FIG. 1, the optical unit 100 is incorporated in the smartphone 200 as an example. Light L enters the smartphone 200 from the outside through the optical unit 100, and a subject image is captured on the basis of the light that enters the optical unit 100. The optical unit 100 is used to correct blur of the captured image when the smartphone 200 shakes. Note that the optical unit 100 may include an imaging element, and the optical unit 100 may include an optical member that transmits light to the imaging element.

The optical unit 100 is preferably manufactured in a small size. In this manner, the smartphone 200 itself can be downsized, or another component can be incorporated in the smartphone 200 without upsizing the smartphone 200.

Note that the application of the optical unit 100 is not limited to the smartphone 200, and the optical unit 100 can be used in various devices such as cameras and videos without particular limitation. For example, the optical unit 100 may be incorporated in, for example, an imaging device such as a mobile phone with a camera or a drive recorder, or an action camera and a wearable camera incorporated in a moving body such as a helmet, a bicycle, or a radio-controlled helicopter.

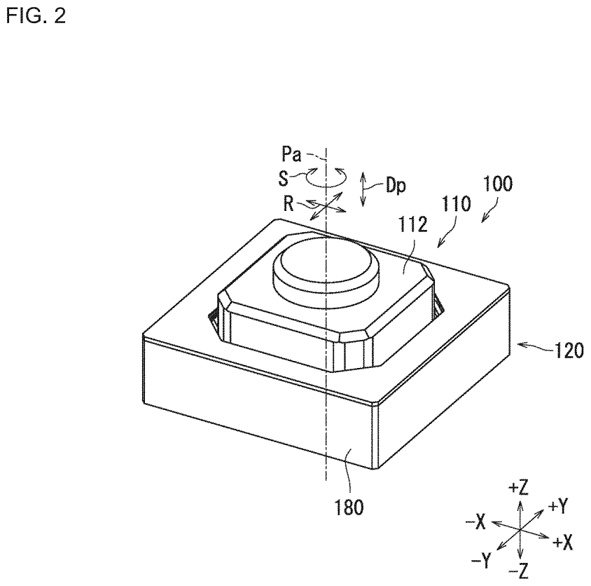

Next, the optical unit 100 according to the present embodiment will be described with reference to FIGS. 1 and 2. FIG. 2 is a schematic perspective view of the optical unit 100 of the present embodiment.

As illustrated in FIG. 2, the optical unit 100 includes a movable body 110 and a fixed body 120. The movable body 110 is swingably supported with respect to the fixed body 120. The fixed body 120 surrounds the movable body 110. The movable body 110 is inserted into the fixed body 120 and held by the fixed body 120. A circuit board 180 may be mounted on an outer surface of the fixed body 120. The circuit board 180 includes, for example, a flexible printed circuit (FPC). The circuit board 180 may be used to transmit a signal for driving the movable body 110. Alternatively, the circuit board 180 may be used to transmit a signal obtained in the movable body 110.

As illustrated in FIG. 2, the movable body 110 includes an optical module 112. Here, the movable body 110 is composed of the optical module 112 alone. However, the movable body 110 may be composed of the optical module 112 and a separate member.

The optical module 112 has an optical axis Pa. The optical axis Pa extends in the Z direction from the center of a surface on the +Z direction side of the movable body 110. Light along the optical axis Pa enters the optical module 112. A light incident surface of the optical module 112 is arranged on a surface on the +Z direction side of the movable body 110. The optical axis Pa extends in the normal direction with respect to the light incident surface. The optical axis Pa extends in an optical axis direction Dp. The optical axis direction Dp is parallel to the normal line of the light incident surface of the optical module 112.

The direction orthogonal to the optical axis direction Dp is a direction intersecting the optical axis Pa and perpendicular to the optical axis Pa. In the present description, a direction orthogonal to the optical axis Pa may be referred to as a “radial direction”. Of the radial directions, radially outward indicates a direction away from the optical axis Pa. In FIG. 2, a reference sign R indicates an example of the radial direction. Further, a direction of rotation about the optical axis Pa may be referred to as a “circumferential direction”. In FIG. 2, a reference sign S indicates the circumferential direction.

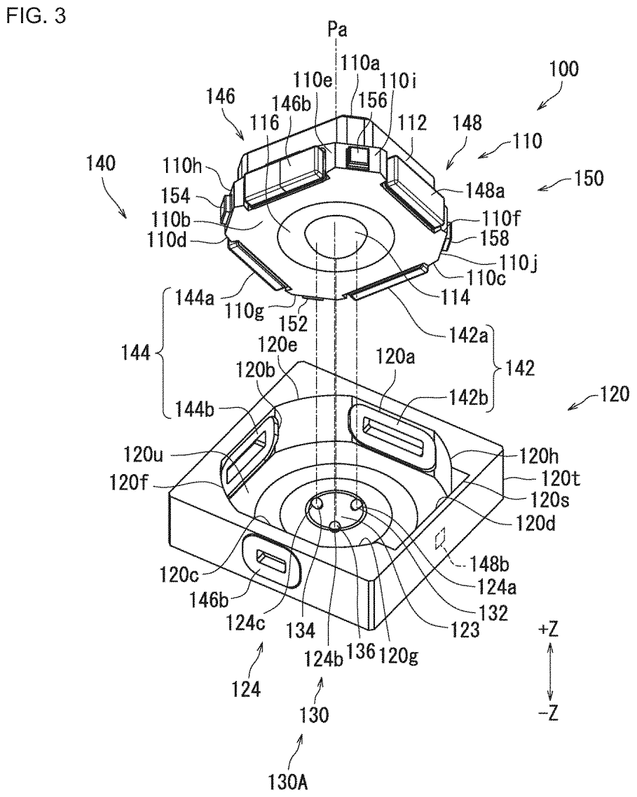

Next, the optical unit 100 of the present embodiment will be described with reference to FIGS. 1 to 3. FIG. 3 is a schematic exploded view of the optical unit 100 of the present embodiment. FIG. 3 illustrates a perspective view on the −Z direction side of the movable body 110 and a perspective view on the +Z direction side of the fixed body 120. Note that, in FIG. 3, illustration of the circuit board 180 of FIG. 2 is omitted.

As illustrated in FIG. 3, the optical unit 100 includes the movable body 110, the fixed body 120, a support portion 130A, a swing mechanism 140, and a protruding portion 150. The movable body 110 is arranged with respect to the fixed body 120. The support portion 130A is arranged on the fixed body 120. The support portion 130A supports the movable body 110. The swing mechanism 140 swings the movable body 110 with respect to the fixed body 120.

When the movable body 110 is inserted into the fixed body 120 and the movable body 110 is mounted on the fixed body 120, the optical axis Pa of the optical module 112 becomes parallel to the Z-axis direction. When the movable body 110 swings with respect to the fixed body 120 from this state, the optical axis Pa of the optical module 112 swings, and the optical axis Pa is no longer parallel to the Z-axis direction.

Hereinafter, it is assumed that the movable body 110 is not swung with respect to the fixed body 120 and the state in which the optical axis Pa is parallel to the Z-axis direction is maintained. That is, in the description of the shape, positional relationship, operation, and the like of the movable body 110, the fixed body 120, and the like with reference to the optical axis Pa, it is assumed that the optical axis Pa is parallel to the Z-axis direction unless the inclination of the optical axis Pa is specifically described.

The support portion 130A is located radially inside about the optical axis Pa with respect to the swing mechanism 140. The protruding portion 150 is arranged on a first one of the movable body 110 and the fixed body 120. The protruding portion 150 protrudes from a first one of the movable body 110 and the fixed body 120 toward a second one of the movable body 110 and the fixed body 120 to interpose a gap between the movable body 110 and the fixed body 120.

Here, the protruding portion 150 is arranged on the movable body 110. The protruding portion 150 protrudes from the movable body 110 toward the fixed body 120 and interposes a gap between the movable body 110 and the fixed body 120. For this reason, the movable body 110 can be easily arranged with respect to the fixed body 120.

The protruding portion 150 projects in a direction intersecting the optical axis direction Dp. Here, the protruding portion 150 extends along the radial direction R.

As described above, the protruding portion 150 is arranged on a first one of the movable body 110 and the fixed body 120. A shortest distance between the protruding portion 150 and a second one of the movable body 110 and the fixed body 120 is shorter than a shortest distance between the movable body 110 and the fixed body 120. For this reason, when the movable body 110 is supported by the support portion 130A located radially inside the swing mechanism 140, the protruding portion 150 protruding from the first one of the movable body 110 and the fixed body 120 toward the second one interposes a gap between the movable body 110 and the fixed body 120. For this reason, the protruding portion 150 can prevent the movable body 110 from being detached from the support of the support portion 130A even if the optical unit 100 receives an impact.

Here, the support portion 130A includes a plurality of support mechanisms 130. A plurality of the support mechanisms 130 support the movable body 110 with respect to the fixed body 120. A plurality of the support mechanisms 130 are arranged on the same circumference around the optical axis Pa.

The swing mechanism 140 swings the movable body 110 supported by the support mechanism 130 with respect to the fixed body 120. The swing mechanism 140 is located radially outside the support mechanism 130. According to the optical unit 100 of the present embodiment, since the support mechanism 130 that supports the movable body 110 is arranged inside the swing mechanism 140, the swing resistance of the movable body 110 can be reduced.

Here, the movable body 110 has a thin substantially rectangular parallelepiped shape. When viewed along the Z-axis, the movable body 110 has a rotationally symmetric structure. The length of the movable body 110 along the X-axis direction is substantially equal to the length of the movable body 110 along the Y-axis direction. Further, the length of the movable body 110 along the Z-axis direction is smaller than the length of the movable body 110 along the X-axis direction or the Y-axis direction.

The movable body 110 has a first main surface 110a, a second main surface 110b, a first side surface 110c, a second side surface 110d, a third side surface 110e, and a fourth side surface 110f. Each of the first side surface 110c, the second side surface 110d, the third side surface 110e and the fourth side surface 110f is connected to the first main surface 110a and the second main surface 110b. The first main surface 110a is located on the +Z direction side, and the second main surface 110b is located on the −Z direction side. The first side surface 110c is located on the +Y direction side, the second side surface 110d is located on the −X direction side, the third side surface 110e is located on the −Y direction side, and the fourth side surface 110f is located on the −X direction side. An area of each of the first main surface 110a and the second main surface 110b is larger than an area of each of the first side surface 110c, the second side surface 110d, the third side surface 110e, and the fourth side surface 110f.

The movable body 110 has a first corner 110g, a second corner 110h, a third corner 110i, and a fourth corner 110j. The first corner 110g is located between the first side surface 110c and the second side surface 110d, and the second corner 110h is located between the second side surface 110d and the third side surface 110e. The third corner 110i is located between the third side surface 110e and the fourth side surface 110f, and the fourth corner 110j is located between the fourth side surface 110f and the first side surface 110c.

The first corner 110g is located on the −X direction side and the +Y direction side, and the second corner 110h is located on the −X direction side and the −Y direction side. The third corner 110i is located on the +X direction side and the −Y direction side, and the fourth corner 110j is located on the +X direction side and the +Y direction side.

Here, the protruding portion 150 is arranged on the movable body 110. For example, the protruding portion 150 is a single member with the movable body 110. However, the protruding portion 150 may be a member different from the movable body 110. The protruding portion 150 is preferably arranged at any of the first corner 110g, the second corner 110h, the third corner 110i, and the fourth corner 110j.

Here, the protruding portion 150 includes a first protruding portion 152, a second protruding portion 154, a third protruding portion 156, and a fourth protruding portion 158. The first protruding portion 152, the second protruding portion 154, the third protruding portion 156, and the fourth protruding portion 158 are located in different directions.

The first protruding portion 152 is located on the −X direction side and the +Y direction side, and is arranged on the first corner 110g. For this reason, the first protruding portion 152 is arranged between the first side surface 110c and the second side surface 110d. The second protruding portion 154 is located on the −X direction side and the −Y direction side, and is arranged on the second corner 110h. For this reason, the second protruding portion 154 is arranged between the second side surface 110d and the third side surface 110e. The third protruding portion 156 is located on the +X direction side and the −Y direction side, and is arranged on the third corner 110i. For this reason, the third protruding portion 156 is arranged between the third side surface 110e and the fourth side surface 110f. The fourth protruding portion 158 is located on the +X direction side and the +Y direction side, and is arranged on the fourth corner 110j. For this reason, the fourth protruding portion 158 is arranged between the fourth side surface 110f and the first side surface 110c. In this manner, it is possible to prevent the movable body 110 from being detached from the support of the support unit 130A in four different directions of the movable body 110 having a thin rectangular parallelepiped shape.

The movable body 110 has a protruding portion 114 protruding in the optical axis direction Dp in which the optical axis Pa extends. The protruding portion 114 is located on the second main surface 110b. The protruding portion 114 has a partial spherical shape.

Note that, here, the movable body 110 has an annular portion 116 surrounding the periphery of the protruding portion 114. The annular portion 116 is located on the second main surface 110b. The annular portion 116 is recessed along the Z direction (optical axis direction Dp) with respect to the protruding portion 114.

The fixed body 120 has a substantially hollow rectangular parallelepiped shape in which a part of a surface on one side is opened. The fixed body 120 has an opening portion. The movable body 110 is placed inside the fixed body 120. For example, the movable body 110 is mounted from the outside of the fixed body 120 to the inside of the fixed body 120.

The fixed body 120 includes a body portion 122 and a recess 124 recessed in the optical axis direction Dp with respect to the body portion 122. The recess 124 faces the protruding portion 114 of the movable body 110.

The fixed body 120 has an inner peripheral surface 120s and an outer peripheral surface 120t. The inner peripheral surface 120s includes a first inner side surface 120a, a second inner side surface 120b, a third inner side surface 120c, a fourth inner side surface 120d, and a bottom surface 120u. The first inner side surface 120a is located on the +Y direction side, and the second inner side surface 120b is located on the −X direction side. The third inner side surface 120c is located on the −Y direction side, and the fourth inner side surface 120d is located on the +X direction side. The bottom surface 120u is located on the −Z direction side. The bottom surface 120u is surrounded by the first inner surface 120a, the second inner surface 120b, the third inner surface 120c, and the fourth inner surface 120d.

The first inner side surface 120a faces the first side surface 110c of the movable body 110. The second inner side surface 120b faces the second side surface 110d of the movable body 110. The third inner side surface 120c faces the third side surface 110e of the movable body 110. The fourth inner side surface 120d faces the fourth side surface 110f of the movable body 110.

The inner peripheral surface 120s has a first corner 120e, a second corner 120f, a third corner 120g, and a fourth corner 120h. The first corner 120e is located between the first inner surface 120a and the second inner surface 120b, and the second corner 120f is located between the second inner surface 120b and the third inner surface 120c. The third corner 120g is located between the third inner surface 120c and the fourth inner surface 120d, and the fourth corner 120h is located between the fourth inner surface 120d and the first inner surface 120a.

The first corner 120e is located on the −X direction side and the +Y direction side, and the second corner 120f is located on the −X direction side and the −Y direction side. The third corner 120g is located on the +X direction side and the −Y direction side, and the fourth corner 120h is located on the +X direction side and the +Y direction side.

The inner peripheral surface 120s of the fixed body 120 is provided with the recess 124. Specifically, the recess 124 is provided on the bottom surface 120u. Here, the recess 124 is located at the center of the bottom surface 120u.

The recess 124 is provided corresponding to a plurality of the support mechanisms 130. Here, specifically, the recess 124 includes a first recess 124a, a second recess 124b, and a third recess 124c. The first recess 124a, the second recess 124b, and the third recess 124c are located on the same circumference around the optical axis Pa. In the present description, the first recess 124a, the second recess 124b, and the third recess 124c may be collectively referred to as the recess 124.

Note that the inner peripheral surface 120s of the fixed body 120 has a central recess 123 recessed along the optical axis direction Dp. The central recess 123 is located radially inside with respect to the recess 124. The central recess 123 has a partial spherical shape.

The support portion 130A includes a plurality of the support mechanisms 130. Each of a plurality of the support mechanisms 130 is located between the recess 124 of the fixed body 120 and the protruding portion 114 of the movable body 110. Each of a plurality of the support mechanisms 130 has a spherical shape or a partial spherical shape. A spherical portion of the support mechanism 130 comes into contact with the protruding portion 114 of the movable body 110, so that the movable body 110 can slide with respect to the support mechanism 130.

A plurality of the support mechanisms 130 are arranged in the recess 124 of the fixed body 120. For example, a plurality of the support mechanisms 130 may be bonded to the recess 124 of the fixed body 120 by an adhesive. When a plurality of the support mechanisms 130 are arranged in the recess 124 of the fixed body 120, a plurality of the support mechanisms 130 protrude from the inner peripheral surface 120s of the fixed body 120 toward the protruding portion 114 of the movable body 110. For this reason, even when the movable body 110 swings with respect to the fixed body 120, it is possible to prevent the movable body 110 from colliding with the fixed body 120.

A plurality of the support mechanisms 130 include a first support mechanism 132, a second support mechanism 134, and a third support mechanism 136. The first support mechanism 132, the second support mechanism 134, and the third support mechanism 136 are arranged at equal intervals. The first support mechanism 132, the second support mechanism 134, and the third support mechanism 136 are arranged in the first recess 124a, the second recess 124b, and the third recess 124c, respectively. For this reason, a plurality of the support mechanisms 130 can stably support the movable body 110 with respect to the fixed body 120.

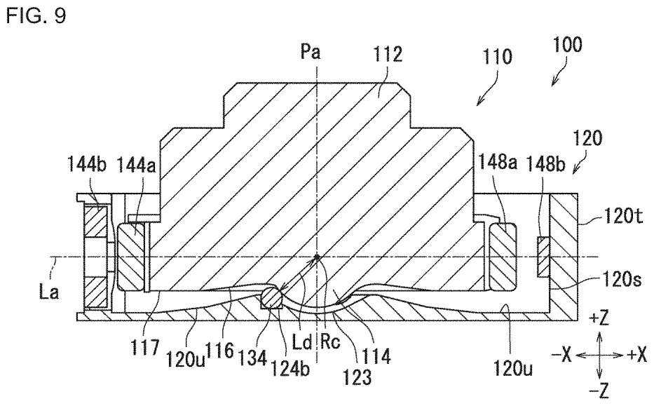

The swing mechanism 140 swings the movable body 110 with respect to the fixed body 120. The swing mechanism 140 swings the movable body 110 with respect to the fixed body 120 about a rotation center Rc (FIG. 9). Typically, with the swing mechanism 140, the movable body 110 swings with respect to the fixed body 120 in a state where the rotation center Rc of the movable body 110 is fixed on the optical axis Pa.

The swing mechanism 140 is located radially outward with respect to the protruding portion 114 of the movable body 110. According to the optical unit 100 of the present embodiment, since the support mechanism 130 that supports the movable body 110 is arranged inside the swing mechanism 140, the swing resistance of the movable body 110 can be reduced.

The swing mechanism 140 includes a first swing mechanism 142, a second swing mechanism 144, and a third swing mechanism 146. The first swing mechanism 142, the second swing mechanism 144, and the third swing mechanism 146 swing the movable body 110 around different axes with respect to the fixed body 120.

The first swing mechanism 142 swings the movable body 110 with respect to the fixed body 120. The first swing mechanism 142 swings the movable body 110 around the X-axis in a state where the rotation center of the movable body 110 is fixed in the XZ plane. Here, the X-axis direction is orthogonal to the optical axis Pa and is the axis of rotation in the yawing direction. The first swing mechanism 142 is located on the +Y direction side of the movable body 110.

The first swing mechanism 142 includes a magnet 142a and a coil 142b. The magnet 142a is magnetized such that the magnetic pole of a surface facing radially outward is different on either side of a magnetization polarization line extending along the X-axis direction. An end portion on a first side along the Z-axis direction of the magnet 142a has a first polarity, and an end portion on a second side has a second polarity.

The magnet 142a is arranged on the first side surface 110c of the movable body 110. The coil 142b is arranged in a through hole penetrating the first inner side surface 120a of the fixed body 120.

By controlling the direction and the magnitude of the current flowing through the coil 142b, the direction and the magnitude of a magnetic field generated from the coil 142b can be changed. Hence, the first swing mechanism 142 swings the movable body 110 around the X-axis by the interaction between the magnetic field generated from the coil 142b and the magnet 142a.

The second swing mechanism 144 swings the movable body 110 with respect to the fixed body 120. The second swing mechanism 144 swings the movable body 110 around the Y-axis in a state where the rotation center of the movable body 110 is fixed in the YZ plane. Here, the Y-axis direction is orthogonal to the optical axis Pa and is the axis of rotation in the pitching direction. The second swinq mechanism 144 is located on the −X direction side of the movable body 110.

The second swing mechanism 144 includes a magnet 144a and a coil 144b. The magnet 144a is magnetized such that the magnetic pole of a surface facing radially outward is different on either side of a magnetization polarization line extending along the X-axis direction. An end portion on a first side along the X-axis direction of the magnet 144a has a first polarity, and an end portion on a second side has a second polarity.

The magnet 144a is arranged on the second side surface 110d of the movable body 110. The coil 144b is arranged in a through hole penetrating the second inner side surface 120b of the fixed body 120.

By controlling the direction and the magnitude of the current flowing through the coil 144b, the direction and the magnitude of a magnetic field generated from the coil 144b can be changed. Hence, the second swing mechanism 144 swings the movable body 110 around the Y-axis by the interaction between the magnetic field generated from the coil 144b and the magnet 144a.

The third swing mechanism 146 swings the movable body 110 with respect to the fixed body 120. Specifically, the third swing mechanism 146 swings the movable body 110 around the Z-axis in a state where the rotation center of the movable body 110 is fixed in the XZ plane. Here, the Z-axis direction is parallel to the optical axis Pa and is an axis of rotation in the rolling direction. The third swing mechanism 146 is located on the −Y direction side of the movable body 110.

The third swing mechanism 146 includes a magnet 146a and a coil 146b. The magnet 146a is magnetized such that the magnetic pole of a surface facing radially outward is different on either side of a magnetization polarization line extending along the Z-axis direction. An end portion on a first side along the X-axis direction of the magnet 146a has a first polarity, and an end portion on a second side has a second polarity.

The magnet 146a is arranged on the third side surface 110e of the movable body 110. The coil 146b is arranged in a through hole penetrating the third inner side surface 120c of the fixed body 120.

By controlling the direction and the magnitude of the current flowing through the coil 146b, the direction and the magnitude of a magnetic field generated from the coil 146b can be changed. Hence, the third swing mechanism 146 swings the movable body 110 around the Z-axis by the interaction between the magnetic field generated from the coil 146b and the magnet 146a.

For example, correction of yawing, pitching, and rolling of the movable body 110 is performed as described below. When shake in at least one of the pitching direction, the yawing direction, and the rolling direction occurs in the optical unit 100, the shake is detected by a magnetic sensor (Hall element) (not illustrated), and based on a result of the detection, the first swing mechanism 142, the second swing mechanism 144, and the third swing mechanism 146 are driven to swing the movable body 110. Note that the shake of the optical unit 100 may be detected using a shake detection sensor (gyroscope) or the like. Based on the detection result of the shake, current is supplied to the coil 142b, the coil 144b, and the coil 146b to correct the shake.

Note that, in the present description, the magnet 142a, the magnet 144a, and the magnet 146a may be collectively referred to as a magnet 140a. In addition, in the present description, the coil 142b, the coil 144b, and the coil 146b may be collectively referred to as a coil 140b.

In the present embodiment, the swing mechanism 140 includes the magnet 140a provided on the movable body 110 and the coil 140b provided on the fixed body 120. The distance between the optical axis Pa and the support mechanism 130 is shorter than the distance between the optical axis Pa and the magnet 140a. By controlling the current flowing through the coil 140b, the movable body 110 can be swung with respect to the fixed body 120.

Here, the magnet 140a is arranged on the movable body 110 and the coil 140b is arranged on the fixed body 120. However, the magnet 140a may be arranged on the fixed body 120 and the coil 140b may be arranged on the movable body 110. As described above, a first one of the magnet 140a and the coil 140b may be arranged on a first one of the movable body 110 and the fixed body 120, and a second one of the magnet 140a and the coil 140b may be arranged on a second one of the movable body 110 and the fixed body 120. By controlling the direction and the magnitude of the current flowing through the coil 140b, the direction and the magnitude of a magnetic field generated from the coil 140b can be changed. Therefore, the swing mechanism 140 can swing the movable body 110 by the interaction between the magnetic field generated from the coil 140b and the magnet 140a.

The X-axis direction is a direction orthogonal to the optical axis direction Dp in which the optical axis Pa of the optical module 112 extends, and is an axis of rotation in the yawing direction. The Y-axis direction is a direction orthogonal to the optical axis direction Dp and the X-axis direction, and serves as an axis of rotation in the pitching direction. The Z-axis direction is parallel to the optical axis direction Dp and is an axis of rotation in the rolling direction. Note that a swing mechanism other than the swing mechanism 140 may swing the movable body 110 with respect to the fixed body 120.

In an optical device including the optical module 112, when the optical device is inclined at the time of imaging, the optical module 112 is inclined, and the captured image is disturbed. In order to avoid disturbance of the captured image, the optical unit 100 corrects the inclination of the optical module 112 on the basis of the acceleration, the angular velocity, the shake amount, and the like detected by detection means such as a gyroscope. In the present embodiment, the optical unit 100 swings (rotates) the movable body 110 in the rotation direction (pitching direction) with at least one of the X-axis, the Y-axis, and the Z-axis as the rotation axis, so that inclination of the optical module 112 is corrected.

Note that the optical unit 100 further includes a magnet 148a and a magnetic body 148b. The magnet 148a is arranged on the fourth side surface 110f of the movable body 110. The magnetic body 148b is arranged on the fourth inner side surface 120d of the fixed body 120. For example, the magnetic body 148b is a hard magnetic body.

In the optical unit 100 of the present embodiment, the support portion 130A is arranged on the bottom surface 120u of the fixed body 120. For this reason, the support portion 130A can be easily arranged on the fixed body 120.

The support portion 130A includes a plurality of the support mechanisms 130 arranged on the same circumference around the optical axis Pa. Since the movable body 110 is supported by a plurality of the support mechanisms 130, the swing resistance of the movable body 110 can be reduced.

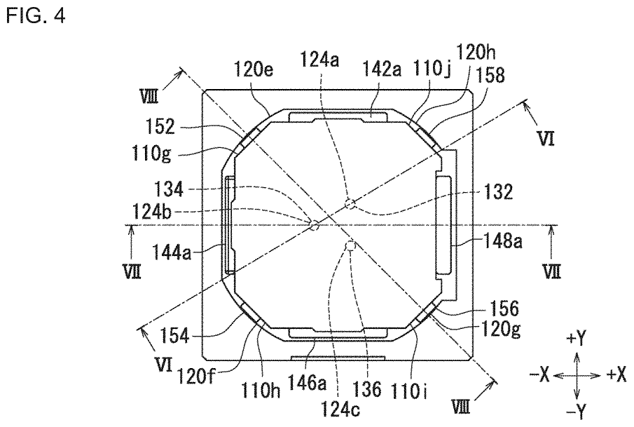

Next, the optical unit 100 of the present embodiment will be described with reference to FIGS. 1 to 8. FIG. 4 is a schematic top view of the optical unit 100 of the present embodiment.

As illustrated in FIG. 4, the movable body 110 is accommodated in the fixed body 120. The first support mechanism 132, the second support mechanism 134, and the third support mechanism 136 are arranged on the fixed body 120. Each of the first support mechanism 132, the second support mechanism 134, and the third support mechanism 136 has a spherical shape.

The optical axis Pa is arranged at the center of the first support mechanism 132, the second support mechanism 134, and the third support mechanism 136. The first support mechanism 132, the second support mechanism 134, and the third support mechanism 136 are located on the same circumference around the optical axis Pa.

A distance from the optical axis Pa to a radially outer end portion of the protruding portion 150 is longer than a distance from the optical axis Pa to a radially outer end portion of the movable body 110. For this reason, when the optical unit 100 receives an impact, the protruding portion 150 is located radially outside the movable body 110, so that the movable body 110 can be prevented from directly colliding with the fixed body 120.

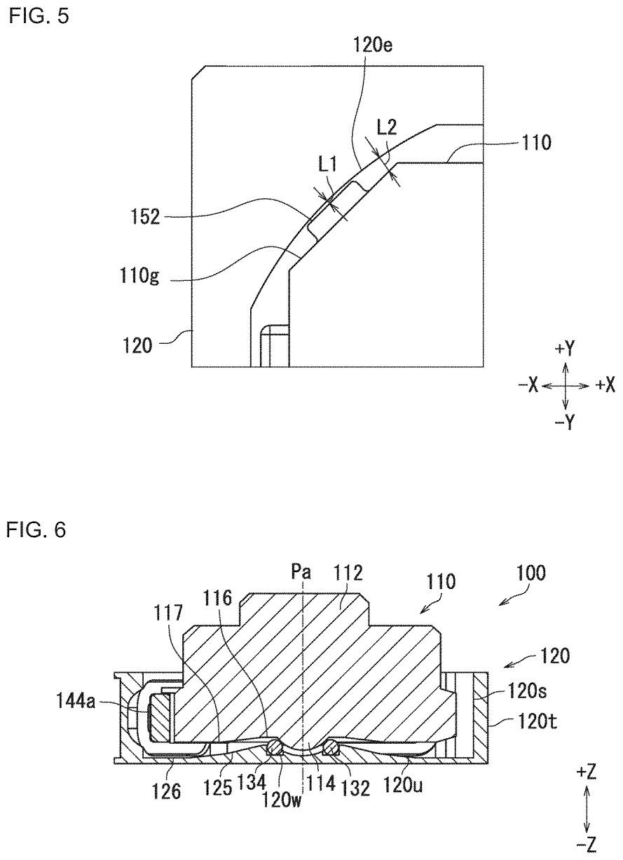

FIG. 5 is an enlarged view of a part of FIG. 4. As illustrated in FIG. 5, the first protruding portion 152 is arranged at the first corner 110g of the movable body 110, and the protruding portion 150 faces the first corner 120e on the inner peripheral surface 120s of the fixed body 120. In a case where the swing mechanism 140 swings the movable body 110, the first protruding portion 152 does not come into contact with the fixed body 120, and the first protruding portion 152 interposes a gap with respect to the first corner 120e of the fixed body 120.

The first protruding portion 152 faces the first corner 120e of the fixed body 120. A distance between the first protruding portion 152 and the first corner 120e of the fixed body 120 indicates a shortest distance L1 between the protruding portion 150 and the fixed body 120.

The movable body 110 faces the first corner 120e of the fixed body 120 at the first corner 120e. A distance between the first corner 120e of the movable body 110 and the first corner 120e of the fixed body 120 indicates a shortest distance L2 between the movable body 110 and the fixed body 120.

The shortest distance L1 between the protruding portion 150 and the fixed body 120 is shorter than the shortest distance L2 between the movable body 110 and the fixed body 120. For this reason, even in a case where the optical unit 100 receives an impact, the protruding portion 150 arranged on the movable body 110 collides with the fixed body 120 before the movable body 110 directly collides with the fixed body 120. Therefore, in the optical unit 100, it is possible to prevent the movable body 110 from colliding with the fixed body 120 in an unintended manner.

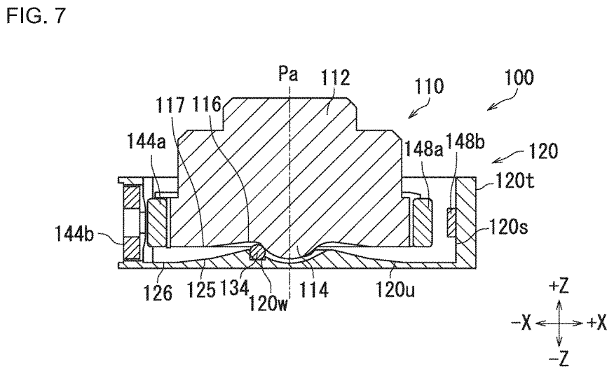

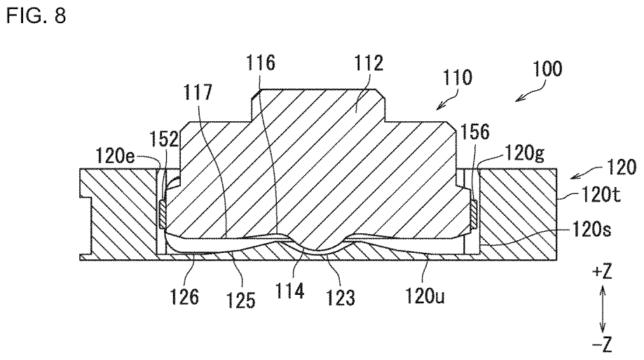

FIG. 6 is a cross-sectional view taken along line VI-VI of FIG. 4, and FIG. 7 is a cross-sectional view taken along line VII-VII of FIG. 4. FIG. 8 is a cross-sectional view taken along the line VIII-VIII of FIG. 4.

As illustrated in FIGS. 4 to 8, the first support mechanism 132, the second support mechanism 134, and the third support mechanism 136 are arranged on the inner peripheral surface 120s of the fixed body 120. The first support mechanism 132, the second support mechanism 134, and the third support mechanism 136 support the movable body 110. Since the movable body 110 is supported by the first support mechanism 132, the second support mechanism 134, and the third support mechanism 136, it is possible to prevent the movable body 110 from being detached from the support of any of a plurality of the support mechanisms 130.

Here, the bottom surface 1201 of the fixed body 120 has a reference surface 126 and a bottom portion 120w recessed with respect to the reference surface 126. A plurality of the support mechanisms 130 are arranged on the bottom portion 120w. For this reason, the support mechanism 130 can be stably arranged on the inner peripheral surface 120s of the fixed body 120.

As illustrated in FIG. 8, a gap is interposed between the first protruding portion 152 and the first corner 120e of the fixed body 120. Further, a gap is interposed between the third protruding portion 156 and the third corner 120g of the fixed body 120. For this reason, the movable body 110 can easily slide with respect to the fixed body 120. Further, even if the optical unit 100 receives an impact, the protruding portion 150 can prevent the movable body 110 from being detached from the support of the support portion 130A.

FIG. 9 is a schematic cross-sectional view of the optical unit 100 of the present embodiment. As illustrated in FIG. 9, an intersection of a straight line La passing through the center of each of the magnet 144a and the coil 144b and the optical axis Pa is the rotation center Rc of the movable body 110. The swing mechanism 140 swings the movable body 110 in a state where the rotation center Rc of the movable body 110 is fixed on the optical axis Pa.

In the optical unit 100 of the present embodiment, a distance Ld between the rotation center Rc of the movable body 110 and the second support mechanism 134 is short. For this reason, since the radius of rotation of the movable body 110 can be made small, the sliding resistance can be reduced.

Note that the inner peripheral surface 120s of the fixed body 120 has the central recess 123. The central recess 123 is recessed in the −Z direction along the optical axis direction Dp as compared with the reference surface 126 and the projection portion 125. The central recess 123 has a partial spherical shape similarly to the protruding portion 114 of the movable body 110. Typically, the radius of curvature of the central recess 123 is substantially equal to or slightly larger than the radius of curvature of the protruding portion 114. For this reason, even if the movable body 110 swings, the protruding portion 114 can be prevented from coming into contact with the inner peripheral surface 120s.

The second main surface 110b of the movable body 110 has the protruding portion 114, the annular portion 116, and a flat portion 117. The flat portion 117 is located radially outside the annular portion 116 with respect to the optical axis Pa. The annular portion 116 is recessed deeper along the optical axis direction Dp on the radially inner side.

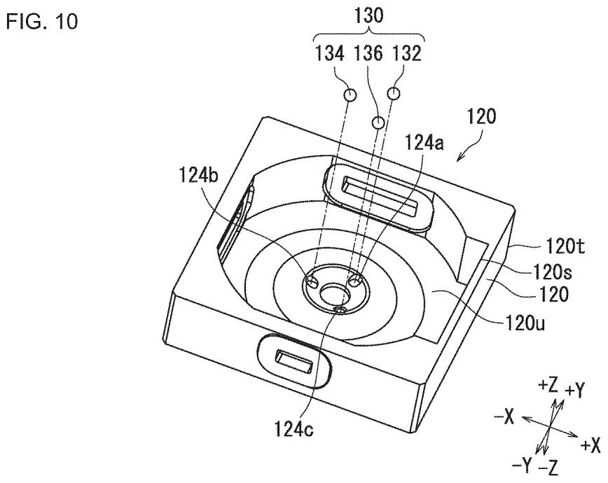

Next, the optical unit 100 of the present embodiment will be described with reference to FIGS. 1 to 10. FIG. 10 is a schematic exploded view of the fixed body 120 in the optical unit 100 of the present embodiment.

As illustrated in FIG. 10, the inner peripheral surface 120s of the fixed body 120 is provided with the recess 124. The recess 124 is provided corresponding to a plurality of the support mechanisms 130. Specifically, the recess 124 includes the first recess 124a corresponding to the first support mechanism 132, the second recess 124b corresponding to the second support mechanism 134, and the third recess 124c corresponding to the third support mechanism 136.

Note that, in the above description with reference to FIGS. 3 to 10, the protruding portion 150 is arranged on a first one of the movable body 110 and the fixed body 120, and protrudes from the first one of the movable body 110 and the fixed body 120 toward a second one, and a portion facing the protruding portion 150 of the movable body 110 and the fixed body 120 is flat. However, the present embodiment is not limited to this configuration. The portion facing the protruding portion 150 of the movable body 110 and the fixed body 120 does not have to be flat.

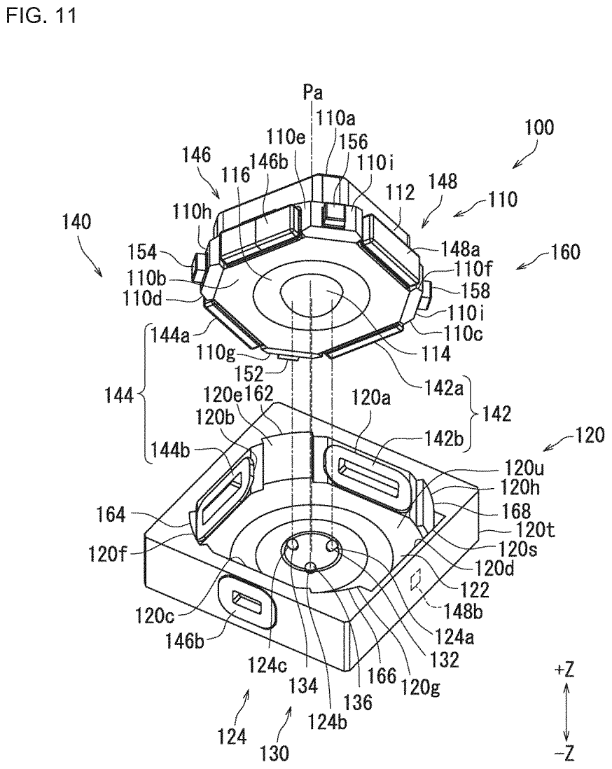

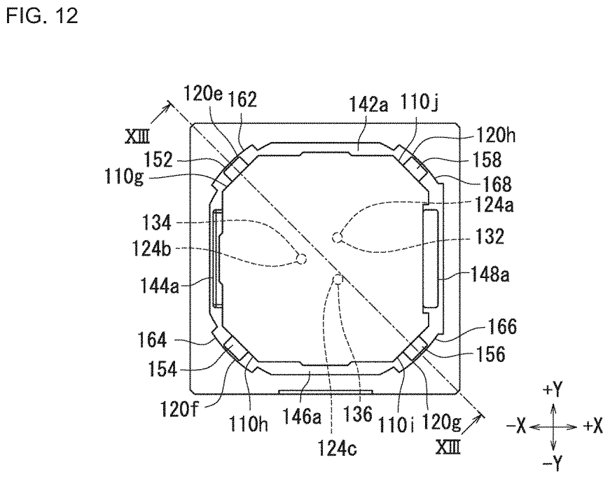

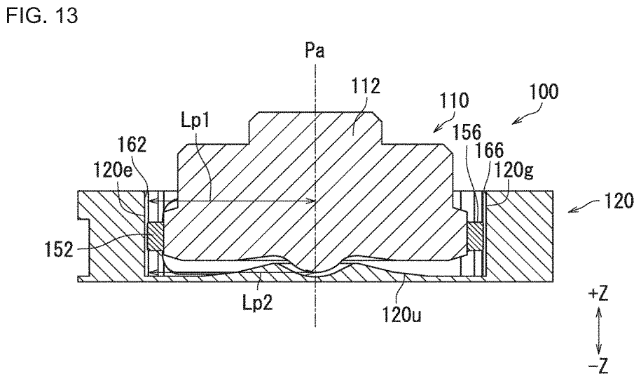

Next, the optical unit 100 according to the present embodiment will be described with reference to FIGS. 11 to 13. FIG. 11 is a schematic exploded view of the optical unit 100 of the present embodiment, FIG. 12 is a schematic top view of the optical unit 100 of the present embodiment, and FIG. 13 is a schematic cross-sectional view of the optical unit 100 of the present embodiment. Note that the optical unit 100 illustrated in FIGS. 11 to 13 has the same configuration as the optical unit 100 described above with reference to FIGS. 3 to 10 except that a recess 160 corresponding to the protruding portion 150 is provided, and duplicate description will be omitted in order to avoid redundancy.

The optical unit 100 further includes the recess 160 in addition to the movable body 110, the fixed body 120, the support portion 130A, the swing mechanism 140, and the protruding portion 150. As described above, the protruding portion 150 is arranged on a first one of the movable body 110 and the fixed body 120, and the recess 160 is provided on a second one of the movable body 110 and the fixed body 120. The recess 160 is recessed in a direction intersecting the optical axis direction Dp. Typically, the recess 160 is recessed in the radial direction. The recess 160 and the protruding portion 150 interpose a gap between the movable body 110 and the fixed body 120. For this reason, the movable body 110 can be easily arranged with respect to the fixed body 120.

Here, the protruding portion 150 is arranged on the movable body 110. The recess 160 is arranged on the fixed body 120. In this manner, the movable body 110 can be easily arranged with respect to the fixed body 120.

The recess 160 preferably restricts the movable body 110 from rotating by a predetermined angle or more about the optical axis Pa. The recess 160 can suppress the rotation of the movable body 110 about the optical axis Pa.

For example, the recess 160 has a step in contact with the protruding portion 150 when the movable body 110 rotates about the optical axis Pa. With the step, the recess 160 can suppress the rotation of the movable body 110 about the optical axis Pa.

Here, the recess 160 includes a first recess 162, a second recess 164, a third recess 166, and a fourth recess 168. The first recess 162, the second recess 164, the third recess 166, and the fourth recess 168 are located in different directions. The first recess 162 is located on the −X direction side and the +Y direction side and faces the first protruding portion 152. For this reason, the first recess 162 is arranged between the first inner side surface 120a and the second inner side surface 120b. The second recess 164 is located on the −X direction side and the −Y direction side and faces the second protruding portion 154. For this reason, the second recess 164 is arranged between the second inner side surface 120b and the third inner side surface 120c. The third recess 166 is located on the +X direction side and the −Y direction side, and faces the third protruding portion 156. For this reason, the third recess 166 is arranged between the third inner side surface 120c and the fourth inner side surface 120d. The fourth recess 168 is located on the +X direction side and the +Y direction side, and faces the fourth protruding portion 158. For this reason, the fourth recess 168 is arranged between the fourth inner side surface 120d and the first inner side surface 120a. In this manner, it is possible to prevent the movable body 110 from being detached from the support of the support portion 130A in four different directions of the optical unit 100 having a thin rectangular parallelepiped shape.

As illustrated in FIG. 13, the inner peripheral surface 120s of the fixed body 120 further has the bottom surface 120u facing the second main surface 110b of the movable body 110. A distance Lp2 between a portion on the bottom surface 120u side of the recess 160 along the optical axis Pa and the optical axis Pa is less than a distance Lp1 between a portion on the opposite side of the bottom surface 120u of the recess 160 along the optical axis Pa and the optical axis Pa. In this manner, when the fixed body 120 is resin-molded using a mold, the fixed body 120 can be easily pulled out from the mold in the optical axis direction Dp.

The swing mechanism 140 includes the first swing mechanism 142 and the second swing mechanism 144 as swing portions that rotate the movable body 110 with a direction perpendicular to the optical axis Pa as a central axis. In a case where the swing portion rotates the movable body 110 with respect to the central axis, a rotation angle from a reference position of the movable body 110 to a position at which the protruding portion 150 comes into contact with the fixed body 120 is larger than a rotation angle from the reference position of the movable body 110 to a position at which the movable body until 110 comes into contact with the fixed body 120. In a case where the swing mechanism 140 rotates the movable body 110, it is possible to prevent the protruding portion 150 from coming into contact with the fixed body 120 before the movable body 110.

Note that, in the optical unit 100 illustrated in FIGS. 3 to 13, the support mechanism 130 is arranged on the bottom portion 120w of the inner peripheral surface 120s of the fixed body 120. However, the present exemplary embodiment is not limited to this configuration. The support mechanism 130 may be arranged in a through hole of the fixed body 120.

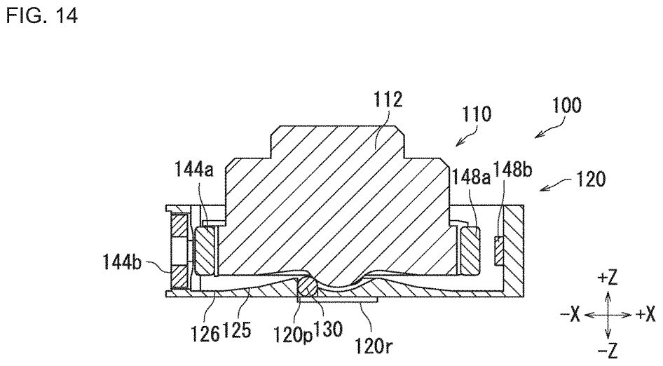

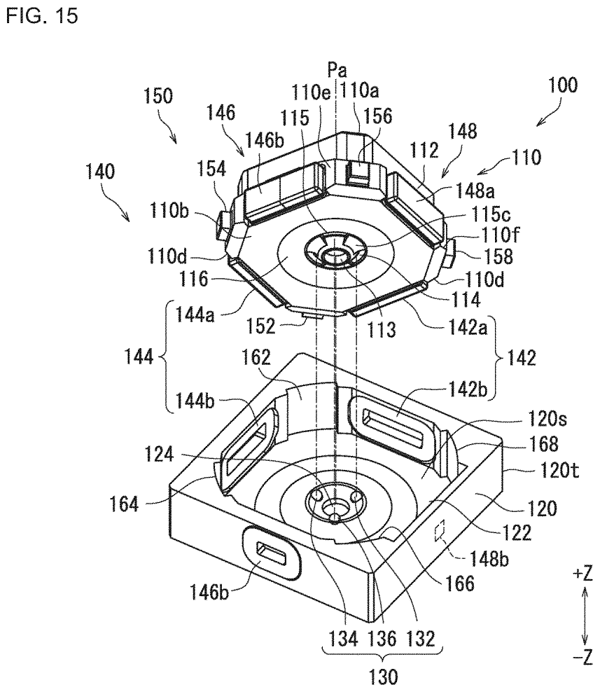

Next, the optical unit 100 according to the present embodiment will be described with reference to FIG. 14. FIG. 15 is a schematic cross-sectional view of the optical unit 100 of the present embodiment.

As illustrated in FIG. 14, the fixed body 120 includes, as the recess 124, a through hole 120p connecting the inner peripheral surface 120s and the outer peripheral surface 120t. A plurality of the support mechanisms 130 are arranged in the through hole 120p. Here, the through hole 120p is covered with a cover member 120r. The cover member 120r covers the outer peripheral surface 120t of the fixed body 120. By arranging the support mechanism 130 in the through hole 120p, appropriate positioning on the inner peripheral surface 120s of the fixed body 120 is possible.

A hole diameter along the XY plane of the through hole 120p is substantially equal to or slightly larger than a diameter along the XY plane of the support mechanism 130. The length along the Z-axis direction of the through hole 120p is larger than the length along the Z-axis direction of the support mechanism 130. For this reason, at least a part of the support mechanism 130 protrudes toward the movable body 110 more than the inner peripheral surface 120s of the fixed body 120.

Note that, in the above description with reference to FIGS. 3 to 14, the protruding portion 114 has a hemispherical shape. However, the present embodiment is not limited to this configuration. The protruding portion 114 does not need to have a hemispherical shape.

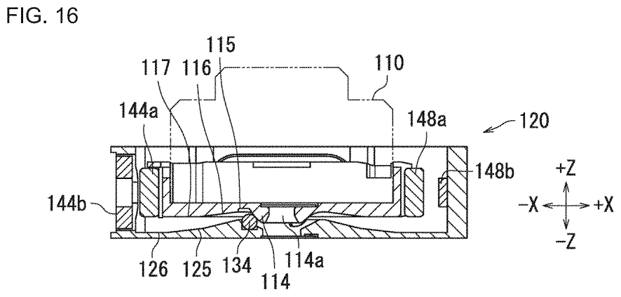

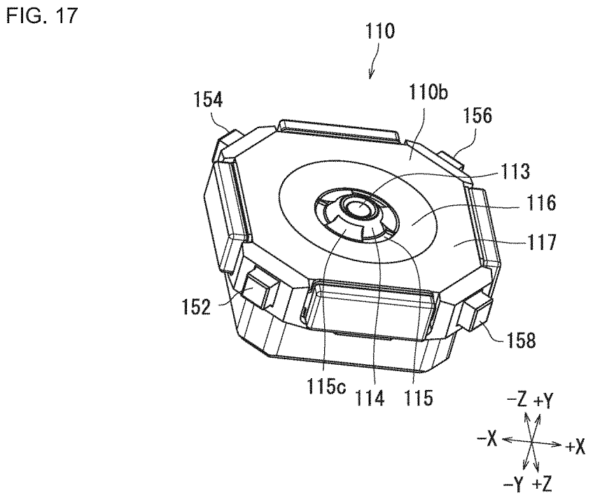

Next, the optical unit 100 of the present embodiment will be described with reference to FIGS. 15 to 17. FIG. 15 is a schematic exploded view of the optical unit 100 of the present embodiment, and FIG. 16 is a schematic cross-sectional view of the optical unit 100 of the present embodiment.

As illustrated in FIG. 15, the movable body 110 includes a central portion 113, the protruding portion 114, and a communication portion 115c. The central portion 113 is surrounded by the protruding portion 114. The central portion 113 is recessed with respect to the protruding portion 114. In this manner, the movable body 110 can be made thin.

The movable body 110 has the groove portion 115 located radially outside the protruding portion 114. The groove portion 115 is located in the direction in which the optical axis Pa extends with respect to the support mechanism 130. Even when the movable body 110 swings with respect to the fixed body 120, it is possible to prevent the movable body 110 from coming into contact with the fixed body 120.

The movable body 110 has the communication portion 115c that protrudes more than the groove portion 115 on the circumferential outside of the groove portion 115 and communicates with the protruding portion 114. In this manner, the strength of the movable body 110 can be improved.

Note that the movable body 110 is preferably attracted by the fixed body 120. In this case, even if the optical unit 100 receives an impact, it is possible to prevent the movable body 110 from being detached from the support of a plurality of the support mechanisms 130.

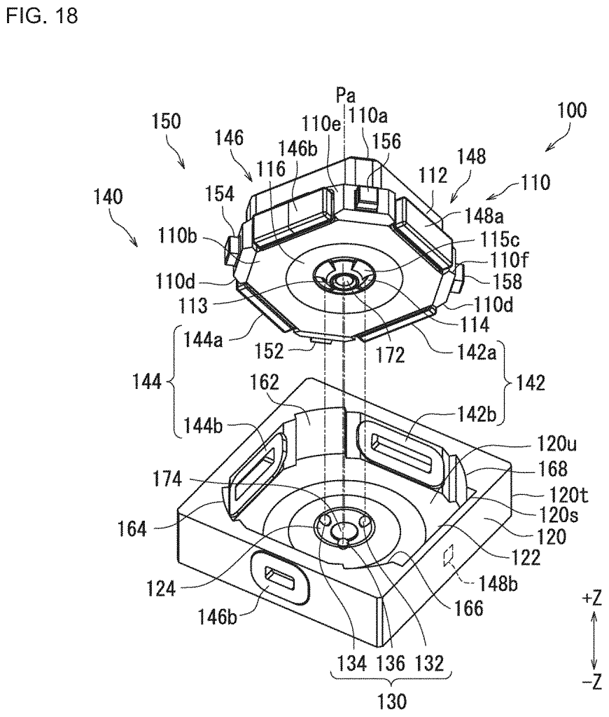

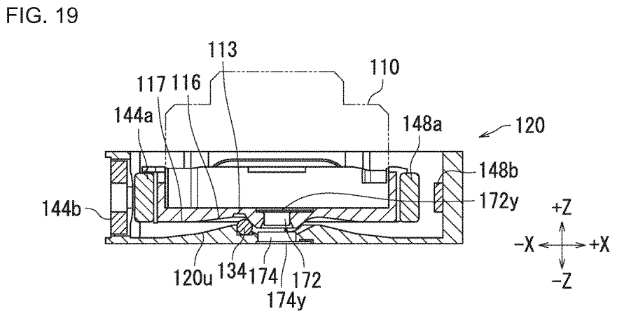

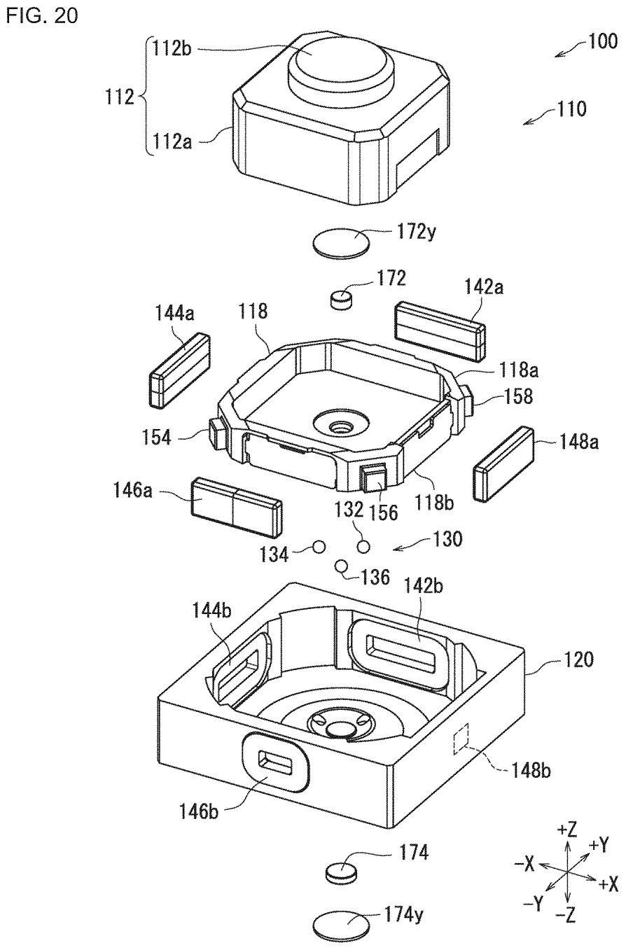

Next, the optical unit 100 of the present embodiment will be described with reference to FIGS. 18 to 20. FIG. 18 is a schematic exploded view of the optical unit 100 of the present embodiment, and FIG. 19 is a schematic cross-sectional view of the optical unit 100 of the present embodiment. FIG. 20 is a schematic cross-sectional view of the optical unit 100 of the present embodiment.

As illustrated in FIGS. 18 to 20, the optical unit 100 further includes a magnet 172 and a magnetic body 174. The optical unit 100 further includes the magnet 172 arranged on a first one of the fixed body 120 and the movable body 110, and the magnetic body 174 arranged on a second one of the fixed body 120 and the movable body 110. The magnetic body 174 is attracted to the magnet 172. The optical axis Pa overlaps the magnet 172 and the magnetic body 174. In this manner, the movable body 110 can be stably supported with respect to the fixed body 120.

Here, the magnet 172 is arranged on the movable body 110, and the magnetic body 174 is arranged on the fixed body 120. Specifically, the magnet 172 is arranged on the central portion 113 of the movable body 110, and the magnetic body 174 is arranged on the central recess 123 of the fixed body 120. The optical axis Pa overlaps the magnet 172 and the magnetic body 174. The movable body 110 can be stably supported with respect to the fixed body 120.

The optical unit 100 further includes a first yoke 172y attached to the magnet 172. The first yoke 172y can increase the magnetic force of the magnet 172.

In the optical unit 100, the magnetic body 174 is a hard magnetic body. The optical unit 100 further includes a second yoke 174y attached to the magnetic body 174. The second yoke 174y can increase the magnetic force of the magnetic body 174.

As illustrated in FIG. 20, the movable body 110 further includes a holder 118 that accommodates the optical module 112. The holder 118 has an inner peripheral surface 118a and an outer peripheral surface 118b. The protruding portion 114 and the protruding portion 150 are located on the outer peripheral surface 118b of the holder 118. Since the protruding portion 114 and the protruding portion 150 are provided in the holder 118 different from the optical module 112, the protruding portion 114 and the protruding portion 150 can be configured with high accuracy.

As illustrated in FIG. 20, the movable body 110 further includes a holder 118 that accommodates the optical module 112. The holder 118 has an inner peripheral surface 118a and an outer peripheral surface 118b. The holder 118 may be provided with the first protruding portion 152, the second protruding portion 154, the third protruding portion 156, and the fourth protruding portion 158. Since the protruding portion 150 is provided in the holder 118 different from the optical module 112, the protruding portion 150 can be configured with high accuracy. The protruding portion 114 is located on the outer peripheral surface of the holder 118. The magnet 172 and the first yoke 172y are arranged in a hole of the holder 118.

The optical module 112 has a housing 112a and a lens 112b. The housing 112a has a thin rectangular parallelepiped shape. The lens 112b is arranged on the housing 112a. The housing 112a may include an imaging element in the inside. The optical module 112 including an imaging element is also called a camera module. When the optical module 112 is inserted into the holder 118, the optical module 112 is held by the holder 118.

For example, the lens 112b is disposed on the optical axis Pa at the center of one surface of the housing 112a. The optical axis Pa and the lens 112b face a subject, and light from a direction along the optical axis direction Dp is incident on the optical module 112.

Note that, in the above description with reference to FIGS. 2 to 20, the movable body 110 is accommodated in the fixed body 120. However, the present embodiment is not limited to this configuration. The movable body 110 and a circuit board may be accommodated in the fixed body 120.

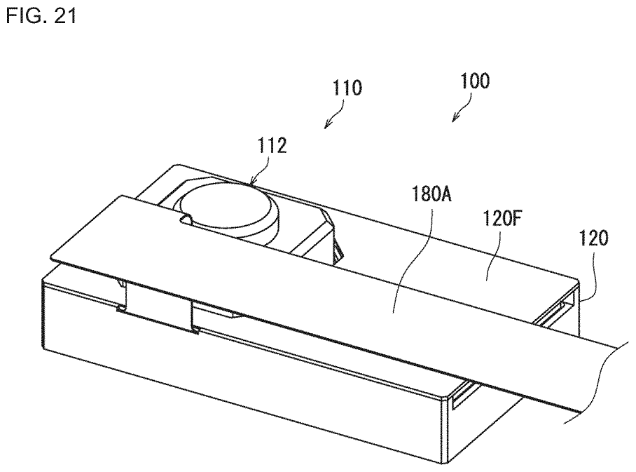

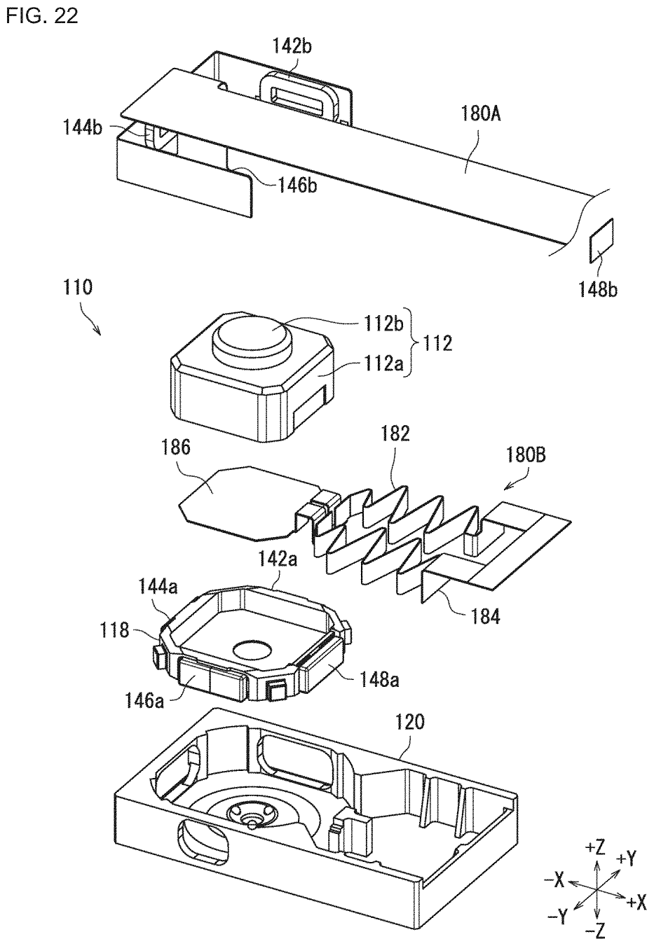

Next, the optical unit 100 according to the present embodiment will be described with reference to FIGS. 21 and 22. FIG. 21 is a schematic perspective view of the optical unit 100 of the present embodiment, and FIG. 22 is a schematic exploded perspective view of the optical unit 100 of the present embodiment. Note that, in FIG. 22, the lid 120F that covers the fixed body 120 is omitted from illustration for the purpose of preventing the diagram from being excessively complicated.

As illustrated in FIGS. 21 and 22, the optical unit 100 further includes the lid 120F, a circuit board 180A, and a circuit board 180B in addition to the movable body 110, the fixed body 120, the support mechanism 130, the swing mechanism 140, the protruding portion 150, and the recess 160. Here, the fixed body 120 extends in the X-axis direction. The lid 120F is located on the +Z direction side with respect to the fixed body 120. The lid 120F covers an opening portion of the fixed body 120. The circuit board 180A or the circuit board 180B includes, for example, a flexible printed circuit (FPC).

The circuit board 180A extends in the X direction. The circuit board 180A is located in the +Z direction of the lid 120F. The coils 142b, 144b, and 146b are attached to the circuit board 180A.

The fixed body 120 accommodates the circuit board 1808 together with the movable body 110. The circuit board 180B is separated into two. The circuit board 180B includes a first circuit board 182 and a second circuit board 184. The first circuit board 182 and the second circuit board 184 have a target structure. Each of the first circuit board 182 and the second circuit board 184 has a bent portion bent in the Y direction.

Note that while FIG. 1 illustrates the smartphone 200 as an example of the application of the optical unit 100 of the present embodiment, the application of the optical unit 100 is not limited to this. The optical unit 100 is preferably used for a digital camera or a video camera. For example, the optical unit 100 may be used as a part of a drive recorder. Alternatively, the optical unit 100 may be mounted on a camera for a flight vehicle (for example, a drone).

Note that, in the optical unit 100 and each member of the optical unit 100 illustrated in FIGS. 2 to 22, the movable body 110 has a substantially thin plate shape. However, the present embodiment is not limited to this configuration. The movable body 110 may have a substantially spherical shape, and the fixed body 120 may swingably support the movable body 110 according to the shape of the movable body 110.

The embodiment of the present invention has been described above with reference to the drawings. However, the present invention is not limited to the above embodiment, and can be implemented in various modes without departing from the gist of the invention. Further, various inventions are possible by appropriately combining the plurality of constituents disclosed in the above embodiment. For example, some constituents may be removed from all the constituents described in the embodiment. Furthermore, constituents across different embodiments may be combined as appropriate. The constituents in the drawings are mainly and schematically illustrated to facilitate better understanding, and the thickness, length, number, spacing, and the like of each constituent illustrated in the drawings may differ from actual values for the convenience of creating drawings. Additionally, the material, shape, dimension, and the like of each constituent element illustrated in the above embodiments are mere examples and are not particularly limited, and various modifications can be made without substantially departing from the effects of the present invention.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An optical unit comprising:
a fixed body;
a movable body having an optical module having an optical axis;
a support portion arranged on the fixed body and supporting the movable body; and
a swing mechanism that swings the movable body with respect to the fixed body, wherein
the support portion is located radially inside about the optical axis with respect to the swing mechanism, the optical unit further comprising:
a protruding portion that is arranged on a first one of the movable body and the fixed body, and protrudes from the first one of the movable body and the fixed body toward a second one to interpose a gap between the movable body and the fixed body, wherein
a shortest distance between the protruding portion and the second one of the movable body and the fixed body is shorter than a shortest distance between the movable body and the fixed body.

2. The optical unit according to claim 1, wherein the protruding portion is arranged on the movable body.

3. The optical unit according to claim 2, wherein a distance from the optical axis to a radially outer end portion of the protruding portion is longer than a distance from the optical axis to a radially outer end portion of the movable body.

4. The optical unit according to claim 1 further comprising:
a recess that is recessed on the second one of the movable body and the fixed body, and forms a gap between the movable body and the fixed body together with the protruding portion.

5. The optical unit according to claim 4, wherein
the protruding portion is arranged on the movable body, and
the recess is arranged on the fixed body.

6. The optical unit according to claim 5, wherein
the movable body has
first and second main surfaces, and
a first side surface, a second side surface, a third side surface, and a fourth side surface, each of which is connected to the first main surface and the second main surface, and
the protruding portion includes
a first protruding portion arranged between the first side surface and the second side surface,
a second protruding portion arranged between the second side surface and the third side surface,
a third protruding portion arranged between the third side surface and the fourth side surface, and
a fourth protruding portion arranged between the fourth side surface and the first side surface.

7. The optical unit according to claim 6, wherein
the fixed body has an inner peripheral surface and an outer peripheral surface,
the inner peripheral surface has
a first inner surface facing the first side surface of the movable body,
a second inner surface facing the second side surface of the movable body,
a third inner surface facing the third side surface of the movable body, and
a fourth inner surface facing the fourth side surface of the movable body, and
the recess includes
a first recess arranged between the first inner surface and the second inner surface,
a second recess arranged between the second inner surface and the third inner surface,
a third recess arranged between the third inner surface and the fourth inner surface, and
a fourth recess arranged between the fourth inner surface and the first inner surface.

8. The optical unit according to claim 7, wherein the recess limits rotation of the movable body about the optical axis by a predetermined angle or more.

9. The optical unit according to claim 8, wherein the recess has a step in contact with the protruding portion when the movable body rotates about the optical axis.

10. The optical unit according to claim 8, wherein
the inner peripheral surface of the fixed body further has a bottom surface facing the second main surface of the movable body, and
a distance between a portion on a bottom surface side of the recess along the optical axis and the optical axis is equal to or less than a distance between a portion on an opposite side of the bottom surface of the recess along the optical axis and the optical axis.

11. The optical unit according to claim 10, wherein the support portion is arranged on the bottom surface of the fixed body.

12. The optical unit according to claim 1, wherein the support portion includes a plurality of support mechanisms arranged on the same circumference around the optical axis.

13. The optical unit according to claim 1, further comprising:
a magnet arranged on a first one of the fixed body and the movable body; and
a magnetic body arranged on a second one of the fixed body and the movable body, wherein
the magnetic body is attracted by the magnet, and
the optical axis overlaps the magnet and the magnetic body.

14. The optical unit according to claim 1, wherein
the swing mechanism includes a swing portion that rotates the movable body about a direction perpendicular to the optical axis as a central axis, and
in a case where the swinging portion rotates the movable body with respect to the central axis, a rotation angle from a reference position of the movable body to a position at which the protruding portion comes into contact with the fixed body is larger than a rotation angle from the reference position of the movable body to a position at which the movable body comes into contact with the fixed body.
